(19) United States
(12) Patent Application Publication
(10) Pub. No.: US 2026/0211890 A1
(43) Pub. Date: Jul. 23, 2026

(54) METHODS AND SYSTEMS FOR IMPROVED STRUCTURED DATA ANALYSIS

(71) Applicant: QlikTech International AB, Lund (SE)

(72) Inventors: Alexei Pogrebtsov, Ottawa (CA); Henrik Svenell, Malmo (SE); Nasser Bumpus, Boston, MA (US)

(21) Appl. No.: 19/454,869

(22) Filed: Jan. 21, 2026

Related U.S. Application Data
(60) Provisional application No. 63/747,497, filed on Jan. 21, 2025.

(51) Int. Cl. G06F 16/2457; G06F 16/22; G06F 16/26

(52) U.S. Cl. CPC G06F 16/24578; G06F 16/2237; G06F 16/26

(57) ABSTRACT

The present disclosure provides a method for analyzing structured data using natural language requests. The method includes receiving a natural language request for analysis of structured data from a user device, determining an analysis type, relevant data fields, and filter conditions using a large language model based on the request, generating an analysis definition and a filters definition based on the determined information, causing an associative engine to process the structured data based on the analysis definition and filters definition, and sending a response to the user device. The response comprises a visualization and a natural language explanation based on the processed structured data.

### CROSS-REFERENCE TO RELATED PATENT APPLICATION

This application claims priority to U.S. Prov. App. No. 63/747,497, filed on Jan. 21, 2025, the entirety of which is incorporated by reference herein.

### BACKGROUND

Data analytics platforms have become increasingly sophisticated, offering powerful tools for businesses to gain insights from their structured data. However, these platforms often require specialized knowledge to operate effectively, limiting their accessibility to non-technical users. Natural language interfaces have emerged as a potential solution, allowing users to interact with data using everyday language. Yet, existing implementations often struggle with complex queries, lack context awareness, and fail to utilize the full potential of underlying data models. There is a growing need for systems that can bridge the gap between natural language input and structured data analysis, providing accurate and contextually relevant responses while maintaining the depth and flexibility of traditional analytics tools.

### SUMMARY

It is to be understood that both the following general description and the following detailed description are exemplary and explanatory only and are not restrictive.

Described herein are methods and systems for improved structured data analysis, such as for processing natural language requests on structured data. The systems and methods may comprise a large language model (LLM) and an associative engine. The LLM may analyze a natural language query to determine an analysis type, relevant data fields, and filter conditions. The associative engine may maintain associations between data elements and perform calculations based on the LLM output.

The system may include metadata filtering to focus on relevant data. It may recommend appropriate data analyses based on the query and available data. The system may associate data fields with analysis parameters and identify filters. The associative engine may generate a hypercube based on the LLM output. This may allow for efficient data analysis without complex conversion of data and queries. The systems and methods described herein may produce visualizations and natural language explanations of the results, thereby providing intuitive exploration of complex data models using natural language, while using the power of associative data analysis.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system, according to aspects of the present disclosure;

FIG. 1B shows an example system, according to aspects of the present disclosure;

FIG. 2 shows an example user interface of an analytics platform, according to aspects of the present disclosure;

FIG. 3 shows an example process, according to aspects of the present disclosure;

FIG. 4A shows an example user interface of an analytics platform, according to aspects of the present disclosure;

FIG. 4B shows an example filters definition, according to aspects of the present disclosure;

FIG. 4C shows an example analysis definition, according to aspects of the present disclosure;

FIG. 5 shows an example user interface of the analytics platform, according to aspects of the present disclosure; and

FIG. 6 shows an example system, according to aspects of the present disclosure;

FIG. 7 shows a flowchart for an example method, according to aspects of the present disclosure;

FIG. 8 shows a flowchart for an example method, according to aspects of the present disclosure; and

FIG. 9 shows a flowchart for an example method, according to aspects of the present disclosure.

### DETAILED DESCRIPTION

This summary is not intended to identify critical or essential features of the disclosure, but merely to summarize certain features and variations thereof. Other details and features will be described in the sections that follow.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

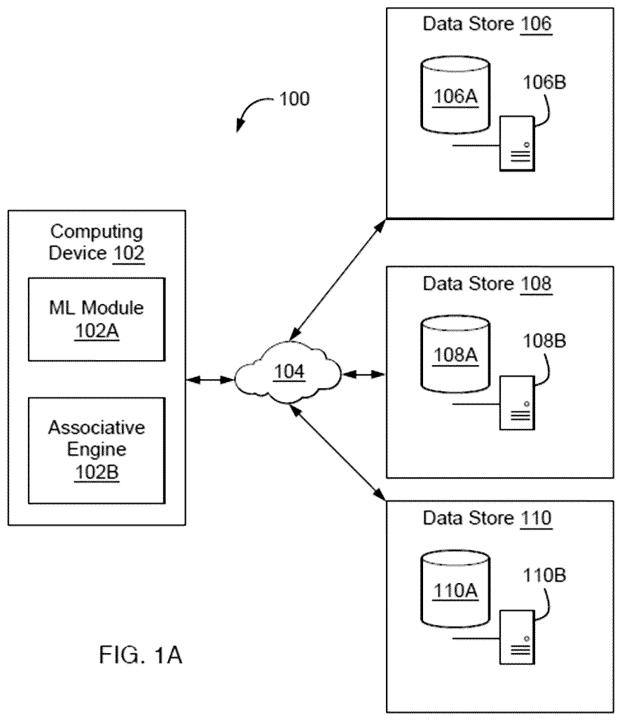

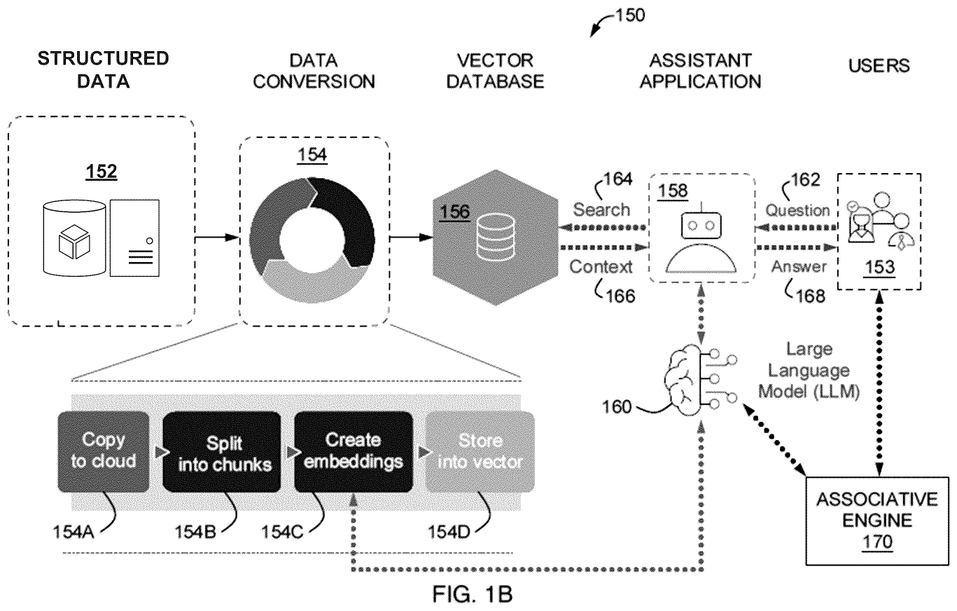

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share - or may each comprise - each described component, resource, device, etc., that performs each of the actions described herein (and potentially not shown).

In some aspects, the system 150 may be utilized to transform structured data 152 into a format that may be consumed by one or more Large Language Models (LLMs). For example, the structured data 152 may comprise structured data related to one or more analytics “apps” as further described herein, which may include one or more data models, data tables, information regarding connections to various sources such as databases, spreadsheets, and/or web services in an analytics system, etc.

The structured data 152 may be split into manageable chunks in a data conversion process 154. At step 154A, the structured data 152 may be copied to a cloud-based environment. At step 154B, the structured data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160. Each embedding may comprise a numerical representation of the corresponding chunk of the structured data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the structured data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the structured data 152), and the context 166 may be used by the assistant application 158 to provide an answer 168 (e.g., a NL answer/output). In this way, the “knowledge” used by the system 150 to provide answers 168 to questions 162 may be based on the structured data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

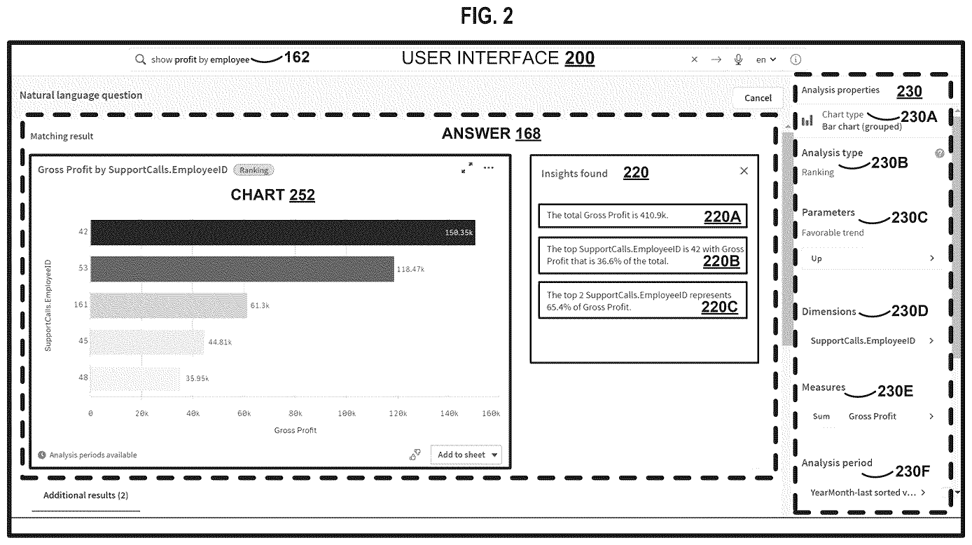

Turning now to FIG. 2, an example user interface 200 is shown. The user interface 200 may provide an interactive environment for users to engage with the natural language processing and insight generation capabilities of the systems described herein. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. The question 162 may be processed by the assistant application 158 as described in relation to FIG. 1B. The input field may support various types of queries, ranging from simple data requests to complex analytical questions. Users may ask questions such as “What were the top products last quarter?” or “Show me sales trends by region.” The system may interpret these natural language inputs and convert them into appropriate data operations.

The user interface 200 may also display an answer 168 in response to the user's question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170. The natural language response may be tailored to the user's specific query and may include relevant details, comparisons, and observations about the data. The answer 168 may comprise natural language text that provides insights, explanations, or responses to the user's query.

A chart 252 may be displayed within the user interface 200. The chart 252 may provide a visual representation of data relevant to the user's query or the current analytical context. The chart 252 may be generated based on data retrieved from the associative engine 170 and/or from the vector database 156. The chart 252 may be interactive, allowing users to click on specific elements to request additional insights or explanations. The visualization may be automatically selected based on the type of analysis being performed and the nature of the data being displayed. The chart 252 may be a visual representation of data relevant to the user's query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 252, the user's query, and other contextual information. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. The analysis properties 230 may be derived from the contextual metadata provided by the associative engine 170 and may include information such as current selection states, hypercube data, statistical measures, and comparative values.

The analysis properties 230 may serve multiple purposes within the system. They may provide the factual foundation for the natural language insights, ensuring that the generated text is grounded in actual data rather than hallucinated information. The properties may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 252 to request explanations or additional insights about specific data points. The system may respond to these interactions by generating new insights or by providing more detailed analysis of the selected elements. This interactive capability may be supported by the associative engine 170. The associative engine 170 can quickly retrieve relevant contextual information about any selected data point or visualization element. The chart 252 and the insights 220 may be dynamically updated based on user interactions. For example, if a user selects a particular bar in the chart 252, the system 150 may generate new insights specific to that selection. This interactive capability may be facilitated by the associative engine 170. The associative engine 170 can quickly retrieve and analyze relevant data based on user selections.

The user interface 200 may also include additional interactive elements not explicitly shown in FIG. 2. These may include filters, dropdown menus, or buttons that allow users to refine their queries, change data views, or access additional features of the system 150. The integration of natural language input, visual data representation, and AI-generated insights in a single interface demonstrates the system's capability to provide a comprehensive analytical experience. This approach may allow users of varying technical expertise to gain valuable insights from complex data sets.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations.

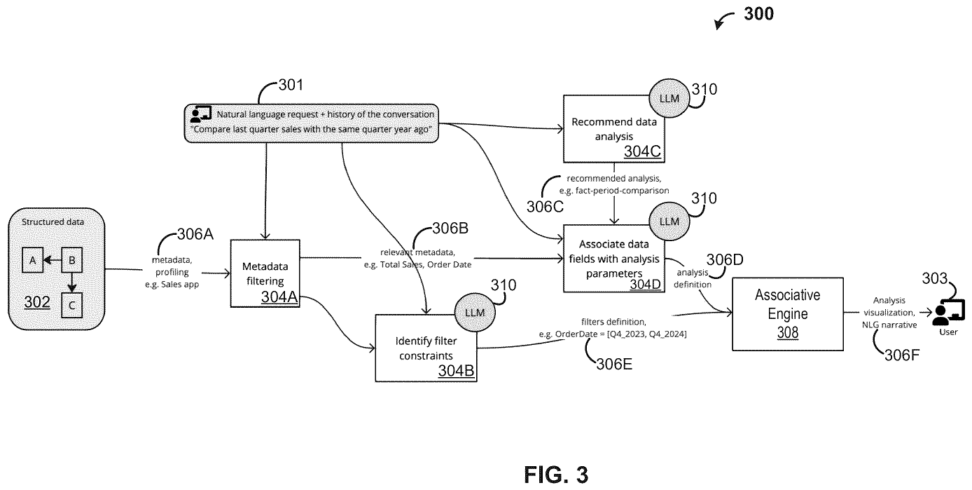

Referring to FIG. 3, a process 300 illustrates an implementation utilizing the system 150 of FIG. 1B. The process 300 may receive a natural language request 301 from a user 303. The user 303 may interact with the process 300 via a user device. The user device may be any computing device capable of sending requests and receiving responses. For example, the user device may be the computing device 102 of FIG. 1A. The user device may be a desktop computer, a laptop, a tablet, a smartphone, or other networked device. Other examples are possible as well.

The process 300 may operate on structured data 302. The structured data 302 may correspond to the structured data 152 of FIG. 1B. The structured data 302 may comprise data related to one or more analytics applications. The structured data 302 may include data models, data tables, and information regarding connections to various sources. The structured data 302 may comprise data organized in a structured manner, such as tables with rows and columns, and associated metadata describing the structure, meaning, and relationships between datasets and fields.

The process 300 may utilize a large language model 310 to process the natural language request 301. The large language model 310 may correspond to the large language model 160 of FIG. 1B. The large language model 310 may analyze the natural language request 301 to determine an analysis type, relevant data fields, and filter conditions. The process 300 uses the large language model 310 primarily for semantic interpretation tasks, including selecting an analysis type, binding parameters to fields, and identifying filters, while delegating computation to an associative engine 308 that maintains associations among data elements. Rather than translating natural language requests into SQL, the process 300 decomposes the natural language request 301 into structured analytic intents comprising analysis type, parameter bindings, and filter constraints, and converts these into an analysis definition and a filters definition for execution by the associative engine 308.

The associative engine 308 may correspond to the associative engine 170 of FIG. 1B. The associative engine 308 may maintain associations between data elements within the structured data 302. The associative engine 308 may process the structured data 302 based on definitions generated by the large language model 310. The associative engine 308 may be an analytics execution engine that maintains associations among data elements and can compute aggregates and drill relationships without requiring explicit SQL joins authored per query. This enables flexible and efficient exploration across complex data models.

The process 300 may generate a response 306F based on the processed structured data 302. The response 306F may be sent to the user 303 via the user device. The response 306F may comprise an analysis visualization and a natural language narrative explaining the results of the data analysis. The response 306F may provide combined visualization and narrative responses enabling intuitive conversational analytics.

In some examples, the natural language request 301 may include historical requests and corresponding responses. The inclusion of historical requests and corresponding responses may allow the process 300 to consider past interactions. The consideration of past interactions may enable the process 300 to provide more contextually relevant analysis. For example, the natural language request 301 may include a conversation history between the user 303 and an assistant application (e.g., the assistant application 158). The conversation history may comprise one or more prior user requests and system responses that may be incorporated to disambiguate or contextualize a current natural language request.

The process 300 may support multi-app or federated analysis across multiple analytics applications. For example, the structured data 302 may comprise data from a plurality of analytics applications. The large language model 310 may identify relevant metadata from the plurality of analytics applications. The associative engine 308 may process data from the plurality of analytics applications to generate the response 306F.

The process 300 may include a metadata profiling 306A step. The metadata profiling 306A may extract metadata describing the data model and application constructs from the structured data 302. The metadata profiling 306A may comprise extraction and analysis of metadata describing the structured data and/or analytics app, including tables, fields, associations and relationships, measures, dimensions, scripts, visualizations, and security rules. For example, the metadata profiling 306A may identify information such as table names, field names, data types, associations between tables, and relationships within the structured data 302. The metadata profiling 306A may also extract information about analytics application constructs. For example, the metadata profiling 306A may identify data connections, load scripts, visualization definitions, master items, and security rules associated with the structured data 302. The metadata profiling 306A may determine that the structured data 302 is associated with a particular application context. For example, the metadata profiling 306A may identify that the structured data 302 is associated with a sales application.

The process 300 may include a metadata filtering step 304A. The metadata filtering step 304A may receive input from the metadata profiling 306A. The metadata filtering step 304A may select a subset of metadata from the metadata profiling 306A. The subset of metadata may be relevant to the natural language request 301. The metadata filtering step 304A may comprise selection of a subset of metadata relevant to a particular natural language request, often using embeddings, similarity search, and/or additional heuristics to keep large language model prompts within practical size and complexity bounds. The metadata filtering step 304A may produce relevant metadata 306B. The relevant metadata 306B may include information such as field names, table names, measures, and dimensions that are pertinent to the natural language request 301. For example, the relevant metadata 306B may include information such as total sales and order date fields when the natural language request 301 relates to sales comparisons. A key scalability mechanism is metadata profiling and metadata filtering. Because real enterprise analytics applications can include very large data models and metadata, the system retrieves only relevant metadata context before forming large language model prompts. This reduces prompt size, improves accuracy, and enables the system to operate across large or complex applications.

The metadata filtering step 304A may use embeddings to filter metadata. For example, the metadata filtering step 304A may convert metadata into vector representations. The vector representations may be stored in a vector database (e.g., the vector database 156). The metadata filtering step 304A may perform similarity searches on the embeddings to identify metadata that is semantically related to the natural language request 301. For example, the metadata filtering step 304A may embed the natural language request 301 and compare the embedded request to embeddings of metadata elements stored in the vector database. The metadata filtering step 304A may retrieve metadata elements that have high similarity scores relative to the embedded natural language request 301. At runtime, the user request can be embedded and used to retrieve the most relevant metadata and context to include in large language model prompts.

The metadata filtering step 304A may employ various metadata filtering strategies. For example, the metadata filtering step 304A may use semantic similarity to identify metadata that is semantically related to the natural language request 301. The metadata filtering step 304A may use schema graph traversal to identify metadata by traversing relationships between tables and fields in the data model. The metadata filtering step 304A may use heuristic scoring to rank metadata elements based on predefined rules or patterns. The metadata filtering step 304A may use hybrid ranking approaches that combine multiple filtering strategies. For example, the metadata filtering step 304A may combine semantic similarity with schema graph traversal to produce the relevant metadata 306B. Other metadata filtering strategies are possible as well.

The process 300 may include a data analysis recommendation step 304C. The data analysis recommendation step 304C may use the large language model 310 to recommend a data analysis type. The recommendation may be based on the natural language request 301 and the relevant metadata 306B. The data analysis recommendation step 304C may produce a recommended analysis 306C. The recommended analysis 306C may specify an analysis type suitable for the natural language request 301. Using the user request and optionally conversation history together with a list of supported analysis types and their parameters, the large language model 310 recommends an analysis type suitable for the request.

The large language model 310 may analyze the structure and content of the data to suggest appropriate analytical approaches. The large language model 310 may use natural language processing capabilities to interpret the natural language request 301. The large language model 310 may match the natural language request 301 with suitable analysis techniques. The ML module 102A of FIG. 1A may facilitate access to the large language model 310. The ML module 102A may comprise and facilitate access to a plurality of machine learning models. The large language model 310 may select from supported analysis types to reduce ambiguity and improve determinism.

With continued reference to FIG. 3, the supported analysis types may comprise a curated set of analysis templates with defined required parameters. The supported analysis types may include a fact period comparison analysis. The fact period comparison analysis may compare a measure across two periods and may require parameters including a measure, a date field, a period A, a period B, and an aggregation. The supported analysis types may include a dimension breakdown analysis. The dimension breakdown analysis may aggregate a measure by one or more dimensions and may require parameters including a measure, one or more dimensions, an aggregation, and a sort. The supported analysis types may include a top-N ranking analysis. The top-N ranking analysis may rank dimension values by a measure and may require parameters including a measure, a dimension, a value N, and a sort. The supported analysis types may include a status comparison analysis. The status comparison analysis may compare measures across statuses such as open versus closed and may require parameters including a status field, status values, a measure, a dimension, and a time filter. The supported analysis types may include a trend over time analysis. The trend over time analysis may show measure trend over time and may require parameters including a measure, a date field, a granularity, and a time window. Other analysis types are possible as well.

The process 300 may include a data field association step 304D. The data field association step 304D may use the large language model 310 to associate data fields with analysis parameters. The data field association step 304D may receive the recommended analysis 306C as input. The data field association step 304D may generate an analysis definition 306D. The analysis definition 306D may specify how data fields map to the parameters required by the selected analysis type. Given the recommended analysis type and a filtered subset of app metadata, the large language model 310 maps required analysis parameters to specific app fields, tables, and measures. For example, the data field association step 304D may map a measure parameter to a total sales field and a date field parameter to an order date field. The field parameter association comprises a mapping of one or more fields from an app's metadata to the parameters required by a selected analysis type.

The system may use multiple components powered by the large language model 310 for different tasks. The tasks may include recommending analysis types. The tasks may include associating data fields with analysis parameters. The tasks may include identifying appropriate filters. The use of the large language model 310 in these various components may enable the system to provide accurate and contextually relevant analysis recommendations and data processing. Instead of a single prompt that attempts to solve all subproblems at once, the pipeline is decomposed into multiple large language model assisted stages. This design improves modularity, simplifies validation, and reduces hallucination risks by narrowing each stage's scope.

Each stage using the large language model 310 may use a dedicated prompt template. The dedicated prompt template may include the user request. The dedicated prompt template may include formatting instructions. The dedicated prompt template may include relevant retrieved metadata and context. The dedicated prompt template may include stage-specific constraints. For example, the stage-specific constraints may include a list of supported analysis types. Each large language model stage uses a dedicated prompt template, typically including the user request, formatting instructions, relevant retrieved metadata and context, and any stage-specific constraints such as the list of supported analysis types. The system architecture may use a single-LLM architecture and/or a multi-agent architecture. The large language model 310 may be a local LLM or a hosted LLM. The large language model 310 may be a fine-tuned model. The large language model 310 may use a prompt-only approach. Other configurations are possible as well.

The process 300 may include a filter constraints identification step 304B. The filter constraints identification step 304B may use the large language model 310 to identify filter constraints from the natural language request 301. The filter constraints identification step 304B may produce a filters definition 306E based on the identified filter constraints. The system identifies filter constraints from the request, such as time windows, regions, or statuses. These constraints are returned in a structured filters definition.

The filters definition 306E may specify constraints derived from the natural language request 301. The filters definition 306E may comprise a structured representation of constraints that restrict or select subsets of data, including time windows, geographic regions, statuses, and threshold ranges. For example, the filters definition 306E may specify time windows.

The filter constraints identification step 304B may work in conjunction with context retrieved from a vector database. The context may be retrieved from the vector database 156 of FIG. 1B. The context 166 may provide relevant metadata and semantic information to assist the large language model 310 in identifying appropriate filter constraints. The large language model 310 may analyze the natural language request 301 together with the context 166 to determine filter constraints that align with the user's intent.

The system may validate that proposed fields specified in the filters definition 306E exist within the structured data 302. The system may validate that the proposed fields match expected data types. The system may validate that the proposed fields are permitted by security rules. If validation fails, the system may request clarification from the user 303. If confidence is low, the system may re-run the filter constraints identification step 304B with adjusted context. The system may validate that proposed fields exist, match expected data types, and are permitted by security rules. If validation fails or confidence is low, the system may request clarification or re-run a stage with adjusted context.

Security rules and access permissions defined in an analytics application may be incorporated into knowledge base construction. The security rules and access permissions may be incorporated into runtime retrieval. The large language model 310 may receive context that the user 303 is authorized to access. The system may filter metadata or data values so that unauthorized information is not provided to the large language model 310. In some embodiments, security rules and access permissions defined in the analytics application are incorporated into both knowledge base construction and runtime retrieval. For example, metadata or data values may be filtered so that the large language model only receives context the user is authorized to access.

The system may retrieve relevant metadata for the filter constraints identification step 304B. The system may avoid transmission of raw sensitive values unless transmission is warranted. Additional controls may include redaction of sensitive information. Additional controls may include token budgeting to manage prompt size. Additional controls may include logging and auditing of prompt content. The system may apply prompt minimization principles by retrieving only relevant metadata and avoiding transmission of raw sensitive values unless necessary. Additional controls may include redaction, token budgeting, and logging and auditing of prompt content.

The system may implement an interactive clarification loop. The interactive clarification loop may be triggered when confidence in the identified filter constraints is low. The system may ask follow-up questions to the user 303. The follow-up questions may request additional information to refine the filters definition 306E. The user 303 may provide responses to the follow-up questions. The system may use the responses to generate an updated filters definition 306E with higher confidence.

Referring to FIG. 3, the analysis definition and the filters definition may be provided to the associative engine 308 for processing the associated structured data. The associative engine 308 may receive the analysis definition and the filters definition as inputs. The associative engine 308 may use the analysis definition and the filters definition to process the structured data and generate a response.

The analysis definition may correspond to a hypercube definition. The analysis definition may comprise a structured representation of the analysis to be executed, derived from the selected analysis type, parameter bindings, and filter constraints. The hypercube definition may specify dimensions for the analysis. The hypercube definition may specify measures for the analysis. The hypercube definition may specify sorting parameters for the analysis. The hypercube definition may specify aggregation functions for the analysis. The hypercube definition may specify other parameters required by the associative engine. For example, the hypercube definition may specify how data fields map to analysis parameters such as a measure field, a date field, and grouping dimensions. In some embodiments, the analysis definition corresponds to a hypercube definition, specifying dimensions, measures, sorting, aggregation functions, and other parameters required by the engine.

With continued reference to FIG. 3, the associative engine 308 may maintain associations between data elements within the structured data. The associative engine 308 may store one or more data models in-memory. The associative engine 308 may manage relationships between data elements without requiring explicit joins per query. The associative engine 308 may compute aggregations based on the maintained associations. The associative engine 308 may traverse relationships between data elements based on the maintained associations. The associative engine 308 maintains associations among data elements and can compute aggregations and relationship traversals without requiring explicit SQL joins per query. This enables flexible and efficient exploration across complex data models.

The associative engine 308 may receive inputs equivalent to inputs the associative engine 308 would receive if a user were clicking and selecting within an analytics application user interface. For example, the analysis definition may specify selections and parameters in a format similar to user selections made through interactive controls in the analytics application user interface. The filters definition may specify filter constraints in a format similar to filter selections made through interactive controls in the analytics application user interface. The associative engine 308 may process the analysis definition and the filters definition in a manner similar to processing user interactions received through the analytics application user interface. From a code standpoint, the associative engine 308 may receive the same type of inputs it would receive if a user were clicking and selecting within the analytics application user interface.

The associative engine 308 may generate a response based on the processed structured data. The response may comprise an analysis visualization. The analysis visualization may be a graphical representation of the analysis results. For example, the analysis visualization may be a bar chart, a scatter plot, a line chart, a KPI tile, or another chart type appropriate for the analysis type. The response may comprise a natural language narrative. The natural language narrative may describe insights derived from the analysis results. The natural language narrative may include summary statistics. The natural language narrative may include trend information. The natural language narrative may include percentage changes or other comparative metrics. The natural language narrative may include deltas. The natural language narrative may include narrative insights. The natural language explanation may be tailored to the user's context and conversation history. The response may be sent to a user device for display to a user.

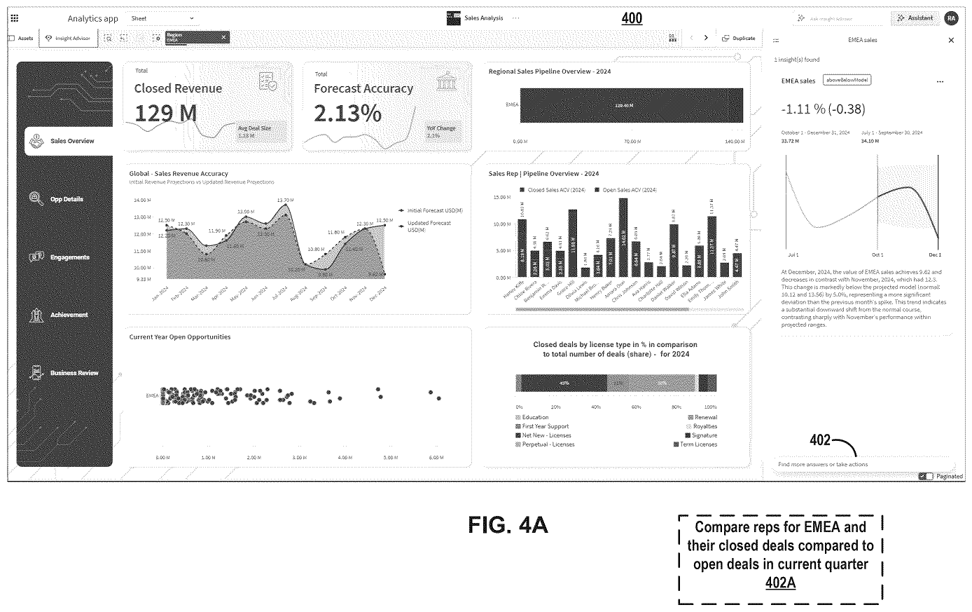

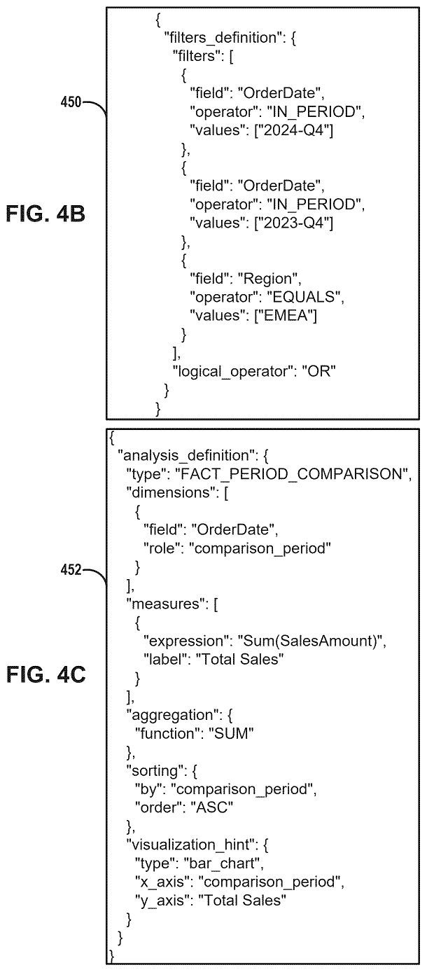

Referring to FIG. 4A, an analytics user interface 400 may be provided for users to interact with the system using natural language queries. The analytics user interface 400 may relate to the user interface 200 of FIG. 2. The analytics user interface 400 may be a component of the assistant application 158 described in relation to FIG. 1B. The analytics user interface 400 may allow users to input natural language queries and receive responses comprising visualizations and natural language explanations.

The analytics user interface 400 may include a chatbox 402. The chatbox 402 may allow users to input natural language queries related to structured data, such as example natural language query 402A. The natural language query 402A may contain text entered by a user. For example, the natural language query 402A may contain the text “Compare reps for EMEA and their closed deals compared to open deals in current quarter.” The natural language query 402A may be an example of the natural language question 162 described in relation to FIG. 1B. The system may infer dimension such as sales rep, region filter such as EMEA, measures such as closed deals and open deals, and time filter such as current quarter, then execute and present comparative visualizations and narrative.

With continued reference to FIG. 4A, the assistant application 158 of FIG. 1B may process the natural language query 402A to generate responses. The assistant application 158 may interact with the large language model 160 to interpret the natural language query 402A. The assistant application 158 may perform a search against the vector database 156 to retrieve context relevant to the natural language query 402A. The assistant application 158 may use the retrieved context to generate an answer comprising visualizations and natural language explanations.

The analytics user interface 400 may display multiple visualizations in a main area of the interface. The analytics user interface 400 may display responses generated by the assistant application 158 in response to the natural language query 402A. The chatbox 402 may also display responses generated by the assistant application 158. The responses displayed in the chatbox 402 may provide contextual information about the visualizations shown in the main area of the analytics user interface 400.

Referring to FIGS. 4B-4C, a filters definition 450 and an analysis definition 452 are depicted as example structured output schemas used in the processing of natural language requests on structured data. For example, the large language model 310 may return structured outputs to reduce ambiguity and support deterministic downstream execution. The structured outputs may comprise JSON objects describing analysis type selection, parameter bindings, and filter constraints. The filters definition 450 comprises a JSON object (or similar) containing filter specifications and a filters_definition property. The filters_definition property includes a filters array containing filter objects. Each filter object may specify a field value, an operator value, and a values array. For example, a first filter object may specify a field value of OrderDate, an operator value of IN_PERIOD, and a values array containing 2024-Q4. A second filter object may specify a field value of OrderDate, an operator value of IN_PERIOD, and a values array containing 2023-Q4. A third filter object may specify a field value of Region, an operator value of EQUALS, and a values array containing EMEA. The filters_definition property may also include a logical_operator property. The logical_operator property may be set to OR to indicate how the filter conditions are combined. Other logical operators may be used as well. The filters definition 450 may correspond to the filters definition 306E of FIG. 3.

With continued reference to FIGS. 4B-4C, the analysis definition 452 comprises a JSON object (or similar) containing an analysis_definition property. The analysis_definition property includes a type value indicating the selected analysis type. For example, the type value may be FACT_PERIOD_COMPARISON. The analysis definition 452 specifies dimensions for the analysis. The dimensions may be specified as an array containing dimension objects. Each dimension object may specify a field value and a role value. For example, a dimension object may specify a field value of OrderDate and a role value of comparison_period. The analysis definition 452 may correspond to the analysis definition 306D of FIG. 3.

The analysis definition 452 specifies measures for the analysis. The measures may be specified as an array containing measure objects. Each measure object may specify an expression value and a label value. For example, a measure object may specify an expression value, such as Sum(SalesAmount), and a label value such as Total Sales. The analysis definition 452 may specify aggregation functions. An aggregation object may specify a function value. For example, the function value may be SUM. Other aggregation functions may be used as well.

The analysis definition 452 specifies sorting for the analysis results. A sorting object may specify a by value and an order value. For example, the sorting object may specify a by value of comparison_period and an order value of ASC. The analysis definition 452 may include visualization hints. A visualization_hint object may specify a type value, an x_axis value, and a y_axis value. For example, the visualization_hint object may specify a type value of bar_chart, an x_axis value of comparison_period, and a y_axis value of Total Sales. The visualization hints provide guidance for rendering the analysis results.

The analysis definition formats may include hypercube definitions, engine-native chart objects, and/or cached analysis templates. The filters definition 450 and the analysis definition 452 support deterministic execution by the associative engine 308 of FIG. 3. The associative engine 308 receives the filters definition 450 and the analysis definition 452 as inputs. The associative engine 308 processes the structured data based on the filters definition 450 and the analysis definition 452 to generate a response. The structured output schemas enable the system to translate natural language requests into executable analysis configurations without ambiguity. This approach avoids brittle natural language to SQL translation for complex data models.

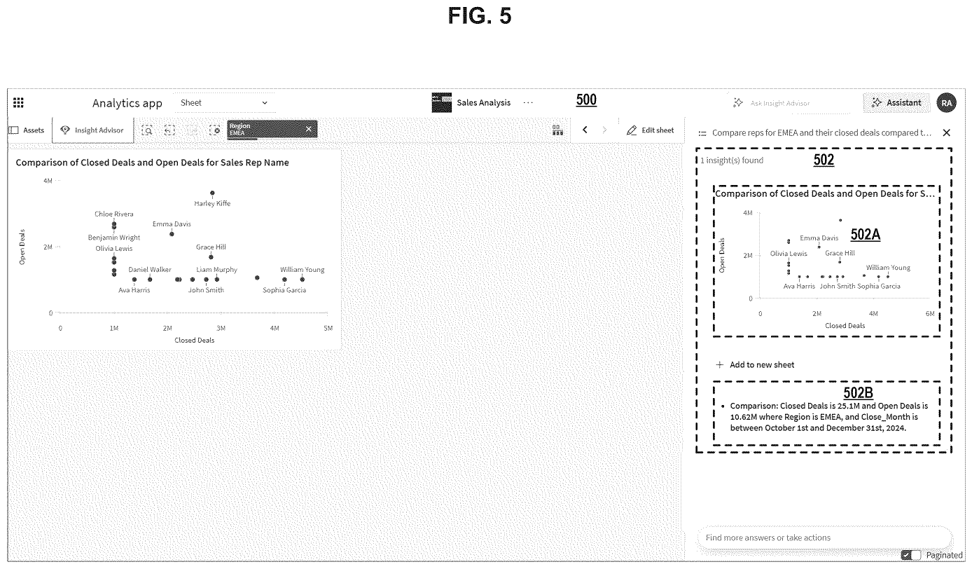

Referring to FIG. 5, an interface 500 may be used to display a response 502 to user queries. The interface 500 may be a component of the system 150 described in FIG. 1B. The interface 500 may be utilized in the process 300 outlined in FIG. 3. The response 502 may correspond to the response 306F generated by the associative engine 308 in the process 300. The response 502 may also correspond to the answer 168 shown in FIG. 2.

The response 502 displayed in the interface 500 may comprise two components: a visualization 502A and a natural language explanation 502B. The visualization 502A may be a graphical representation of data relevant to the user's query. For example, the visualization 502A may be shown as a scatter plot chart. The scatter plot chart may display data points for multiple sales representatives. The visualization 502A may display closed deals on a vertical axis and open deals on a horizontal axis. Based on the processed structured data, the system generates one or more visualizations such as bar charts, scatter plots, or KPI tiles appropriate for the analysis type and user intent.

The natural language explanation 502B may be included in the response 502. The natural language explanation 502B may provide a textual description or interpretation of the data presented in the visualization 502A. That is, the natural language explanation 502B may provide context for understanding the visualization 502A. The natural language explanation 502B may include summary statistics, trends, deltas, percent changes, narrative insights, etc. The narrative insights may be tailored to the user's context. The narrative insights may be tailored to the conversation history. Further, the natural language explanation 502B may specify filter conditions applied to the data. For example, the natural language explanation 502B may indicate a region filter and a time period filter.

The response 502 may be generated through the process 300 described in FIG. 3. For example, as part of executing the process 300, the system 150 may utilize the assistant application 158 and the large language model 160 to generate the natural language explanation 502B. The visualization 502A in the response 502 may be based on data retrieved from the vector database 156 in the system 150. The visualization 502A may be dynamically generated based on the specific query and the relevant data identified by the system 150. The combination of the visualization 502A and the natural language explanation 502B in the response 502 may provide users with a comprehensive understanding of data analysis results. The interface 500 may support alternative response modalities. Alternative response modalities may include text-only responses, dashboard-only responses, multimodal responses, and/or exportable reports. Other examples are possible as well.

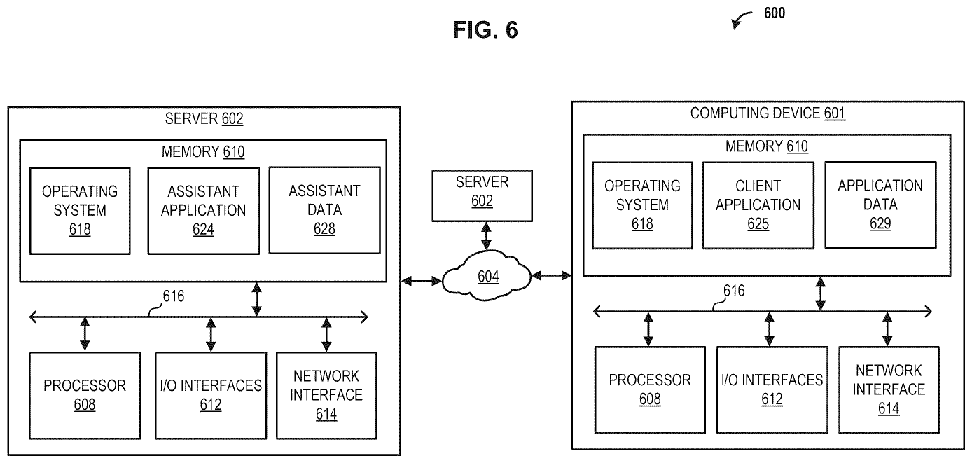

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1A. In an aspect, some or all steps of any described method may be performed on a computing device as described herein. The computing device 601 may comprise one or multiple computers configured to store application data 629, and/or the like. The server 602 may comprise one or multiple computers configured to store assistant data 629. Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the application data 629, the client application 625, and a suitable operating system (O/S) 618. In the example of FIG. 6, the software in the system memory 610 of the server 602 may comprise the assistant data 628, the assistant application 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

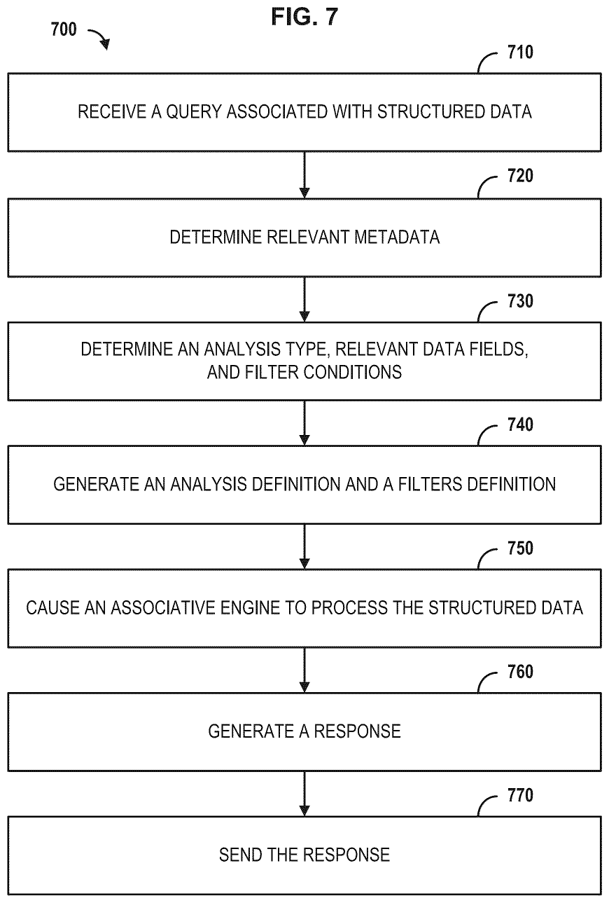

Referring to FIG. 7, a method 700 for processing a query associated with structured data is shown. The method 700 may be performed by one or more computing devices, such as the computing device 102, the large language model 160, and the associative engine 170. The method 700 may enable natural language analytics over complex structured data models.

At step 710, a query associated with structured data may be received. The query may be a natural language request for analysis of the structured data, such as the natural language request 301 or the natural language question 162. For example, the query may be received from a user device. The query may comprise a natural language question or instruction. For example, the query may comprise a request to compare sales figures across different time periods, similar to the natural language query 402A shown in the chatbox 402. The query may be received via a user interface, such as the user interface 200 or via the chatbox 402 within the analytics user interface 400. The query may optionally include conversation history. The conversation history may comprise one or more prior user requests and system responses. The conversation history may be incorporated to disambiguate or contextualize the current query.

At step 720, relevant metadata may be determined. The relevant metadata may be associated with the structured data (e.g., the structured data 152 or the structured data 302). Step 720 may involve metadata profiling, such as the metadata profiling 306A. Metadata profiling may comprise extraction and analysis of metadata describing the structured data. The metadata may describe tables, fields, associations, relationships, measures, dimensions, scripts, visualizations, and security rules. Step 720 may involve metadata filtering, such as the metadata filtering step 304A. Metadata filtering may comprise selection of a subset of metadata relevant to the query, producing relevant metadata (e.g., the relevant metadata 306B). The metadata filtering may use embeddings and similarity search. For example, the query may be embedded and used to retrieve relevant metadata from a vector database, such as the vector database 156. The metadata filtering may use additional heuristics to keep prompts within practical size and complexity bounds. The metadata filtering may use semantic similarity, schema graph traversal, heuristic scoring, or hybrid ranking strategies.

At step 730, an analysis type, relevant data fields, and filter conditions may be determined. The determination may be based on the query and the relevant metadata (e.g., the relevant metadata 306B). The determination may be performed using a large language model, such as the large language model 160/310. Step 730 may involve multiple sub-stages. A first sub-stage may comprise analysis recommendation, corresponding to the data analysis recommendation step 304C. The large language model 310 may recommend an analysis type from a list of supported analysis types, producing a recommended analysis (e.g., the recommended analysis 306C). The supported analysis types may comprise a curated set of analysis templates with defined parameters. For example, the supported analysis types may include fact period comparison, dimension breakdown, top-N ranking, status comparison, and trend over time analysis types. The large language model 310 may select an analysis type suitable for the query. For example, for a query requesting comparison of sales across time periods, the large language model 310 may recommend a fact period comparison analysis type.

A second sub-stage of step 730 may comprise field-to-parameter association, corresponding to the data field association step 304D. The large language model 310 may map analysis parameters to specific data fields. The analysis parameters may be named inputs required to define the selected analysis type. For example, the analysis parameters may include a measure field, a date field, period identifiers, and grouping dimensions. The large language model 310 may associate data fields from the relevant metadata 306B with the analysis parameters. For example, the large language model 310 may associate a total sales field with a measure parameter and an order date field with a date field parameter.

A third sub-stage of step 730 may comprise filter identification, corresponding to the filter constraints identification step 304B. The large language model 310 may identify filter constraints from the query. The filter constraints may comprise time windows, geographic regions, statuses, or threshold ranges. For example, for a query requesting comparison of last quarter sales with the same quarter from a previous year, the large language model 310 may identify filter constraints specifying the two time periods.

At step 740, an analysis definition (e.g., the analysis definition 306D or the analysis definition 452) and a filters definition (e.g., the filters definition 306E or the filters definition 450) may be generated. The analysis definition and the filters definition may be generated based on the determined analysis type, relevant data fields, and filter conditions. The analysis definition may comprise a structured representation of the analysis to be executed. For example, the analysis definition may correspond to a hypercube definition. The hypercube definition may specify dimensions, measures, sorting, aggregation functions, and other parameters, as illustrated in the analysis definition 452. The analysis definition may be derived from the selected analysis type and the parameter bindings.

The filters definition may comprise a structured representation of constraints. The constraints may restrict or select subsets of data. The filters definition may specify field identifiers, operators, and values, as illustrated in the filters definition 450. For example, the filters definition may specify an order date field with an in-period operator and a value indicating a specific quarter. The analysis definition and the filters definition may be returned as structured outputs. For example, the analysis definition and the filters definition may be returned as JSON objects. The structured outputs may reduce ambiguity and support deterministic downstream execution.

At step 750, an associative engine may be caused to process the structured data. The associative engine (e.g., the associative engine 170) may be caused to process the structured data using the analysis definition and the filters definition. For example, the associative engine may receive the analysis definition 306D and the filters definition 306E. The associative engine may maintain associations among data elements. The associative engine may compute aggregates and drill relationships without requiring explicit SQL joins authored per query. The associative engine may receive inputs similar to inputs received when a user clicks and selects within an analytics application user interface, such as the analytics user interface 400. The associative engine may execute the analysis definition against the structured data with the filter constraints applied.

At step 760, a response may be generated. The response (e.g., the response 306F or the response 502) may be generated based on the processed structured data. The response may comprise a visualization (e.g., the visualization 502A or the chart 252). The visualization may be generated based on the processed structured data. For example, the visualization may comprise a bar chart, a scatter plot, or a KPI tile. The visualization may be appropriate for the analysis type and user intent. The response may comprise a natural language explanation (e.g., the natural language explanation 502B or the answer 168). The natural language explanation may describe the result of the analysis. The natural language explanation may include summary statistics, trends, deltas, percent changes, or narrative insights. The natural language explanation may be tailored to the user context and conversation history.

At step 770, a response to the query may be sent. The response may be sent to a user device. For example, the response may be sent to the user device from which the query was received. The response may be displayed in a user interface, such as the interface 500 or the user interface 200. For example, the response may be displayed in an analytics user interface comprising the visualization 502A and the natural language explanation 502B. The response may enable intuitive exploration of complex data models using natural language while leveraging associative data analysis capabilities.

The method 700 may include validation and correction operations. The system 150 may validate that proposed fields exist, match expected data types, and are permitted by security rules. If validation fails or confidence is low, the system 150 may request clarification or re-run a stage with adjusted context. The method 700 may incorporate security rules and permission-aware retrieval. Metadata or data values may be filtered so that the large language model receives context the user is authorized to access. Other examples are possible as well.

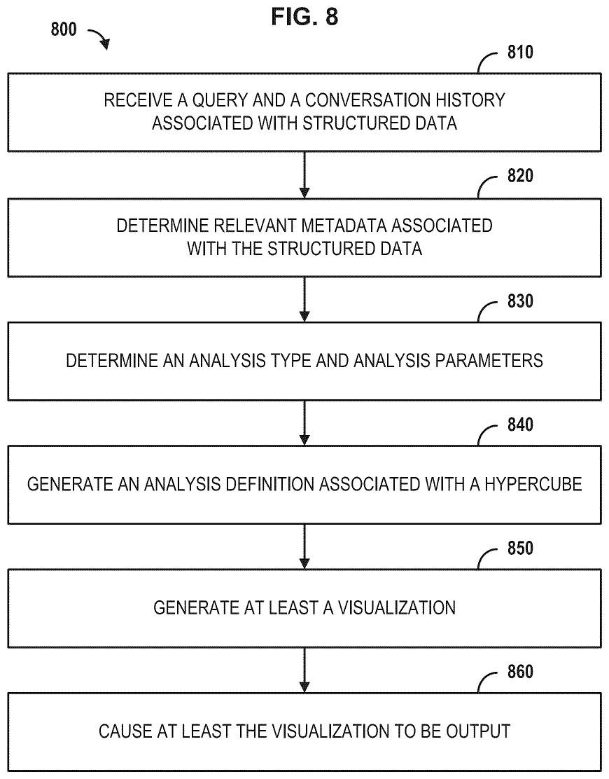

Referring to FIG. 8, a method 800 for processing natural language requests on structured data is illustrated. The method 800 may be performed by one or more computing devices, such as the computing device 102 or the server 602. For example, the method 800 may be performed by one or more entities of the system 150, such as the large language model 160 and the associative engine 170. The method 800 may leverage conversation history to provide context for processing queries against structured data.

At step 810, a query and a conversation history associated with structured data may be received. The query may comprise a natural language request for analysis of the structured data, such as the natural language request 301 or the natural language question 162. For example, the query may request a comparison of sales figures across different time periods. The conversation history may comprise one or more prior user requests and system responses. The conversation history may be incorporated to disambiguate or contextualize the current query. For example, the conversation history may provide context similar to the context 166. The conversation history may enable the system 150 to understand the user's 153 intent and preferences based on prior interactions. The structured data (e.g., the structured data 152 or the structured data 302) may comprise data related to one or more analytics applications. Each analytics application may comprise a data model, data tables, and information regarding connections to data sources.

At step 820, relevant metadata associated with the structured data may be determined. Step 820 may involve metadata profiling (e.g., the metadata profiling 306A) to extract metadata describing the data model and application constructs. The metadata profiling may identify information such as tables, fields, associations, measures, dimensions, scripts, visualizations, and security rules. Step 820 may involve metadata filtering (e.g., the metadata filtering step 304A) to select a subset of metadata relevant to the query, producing relevant metadata (e.g., the relevant metadata 306B). The metadata filtering may use embeddings and similarity search to identify relevant metadata from the vector database 156. The metadata filtering may use additional heuristics to keep prompts within practical size and complexity bounds. The system 150 may periodically capture static data extracts or snapshots of the data used in the analytics application to ensure the vector database 156 remains current and accurate. The relevant metadata 306B may include information such as measure fields and date fields associated with the query.

At step 830, an analysis type and analysis parameters may be determined. Step 830 may use a large language model (e.g., the large language model 160 or the large language model 310) to recommend an analysis type from a list of supported analysis types, corresponding to the data analysis recommendation step 304C. The supported analysis types may comprise a curated set of analysis templates with defined parameters. For example, the supported analysis types may include fact period comparison, dimension breakdown, top-N ranking, status comparison, and trend over time analysis types. The large language model 310 may analyze the query and the conversation history together with the list of supported analysis types. The large language model 310 may return a structured output describing the analysis type selection, producing a recommended analysis (e.g., the recommended analysis 306C). The structured output may include a confidence score for the recommended analysis type. Step 830 may also determine analysis parameters associated with the selected analysis type, corresponding to the data field association step 304D. The analysis parameters may comprise named inputs such as measure field, date field, period values, and grouping dimensions. The large language model 310 may map the analysis parameters to specific fields from the relevant metadata 306B.

At a step 840, an analysis definition (e.g., the analysis definition 306D or the analysis definition 452) associated with a hypercube may be generated. The analysis definition may comprise a structured representation of the analysis to be executed. The analysis definition may correspond to a hypercube definition that specifies dimensions, measures, sorting, aggregation functions, and other parameters, as illustrated in the analysis definition 452. The analysis definition may be derived from the selected analysis type and the parameter bindings. Step 840 may also generate a filters definition (e.g., the filters definition 306E or the filters definition 450). The filters definition may comprise a structured representation of constraints. The constraints may restrict or select subsets of data. For example, the constraints may specify time windows, geographic regions, statuses, or threshold ranges, as illustrated in the filters definition 450. The filters definition may be derived from the query and the conversation history. The analysis definition 306D and the filters definition 306E may be provided to an associative engine, such as the associative engine 308.

At step 850, at least a visualization may be generated. For example, at step 850, the associative engine 308 may be caused to process the structured data using the analysis definition 306D and the filters definition 306E. The associative engine 308 may maintain associations among data elements. The associative engine 308 may compute aggregations and relationship traversals without requiring explicit SQL joins per query. The associative engine 308 may receive the analysis definition 306D and the filters definition 306E as inputs. The associative engine 308 may execute the analysis against the structured data. Based on the processed structured data, the visualization (e.g., the visualization 502A or the chart 252) may be generated. The visualization may comprise a bar chart, a scatter plot, a KPI tile, or another graphical representation. The visualization may be appropriate for the analysis type and the user intent.

At step 860, at least the visualization may be caused to be output. For example, at step 860, a response (e.g., the response 306F or the response 502) comprising the visualization 502A may be sent to the user device for output. The response may also comprise a natural language explanation (e.g., the natural language explanation 502B or the answer 168). The natural language explanation may describe the result of the analysis. The natural language explanation may include summary statistics, trends, deltas, percent changes, and/or narrative insights. Other examples are possible as well. The natural language explanation may be tailored to the user's 153 context and the conversation history. The response may be displayed within a user interface, such as the interface 500 or the analytics user interface 400. The user interface may comprise a chatbox (e.g., the chatbox 402) for receiving natural language queries. Other examples are possible as well.

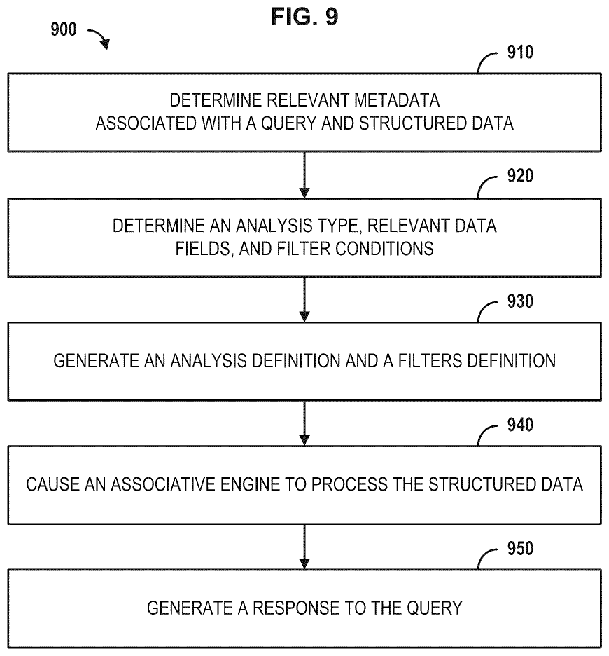

Referring to FIG. 9, a method 900 for processing natural language requests on structured data is shown. The method 900 may be performed by one or more computing devices, such as the computing device 102. The method 900 may correspond to portions of the process 300 described with reference to FIG. 3. The method 900 may leverage a large language model (e.g., the large language model 160 or the large language model 310) for semantic interpretation tasks while delegating computation to an associative engine (e.g., the associative engine 170 or the associative engine 308).

At step 910, relevant metadata associated with a query and structured data may be determined. The query may comprise a natural language request from a user (e.g., the user 153 or the user 303). The structured data (e.g., the structured data 152 or the structured data 302) may comprise data organized in a structured manner. For example, the structured data may comprise tables with rows and columns and associated metadata describing the structure, meaning, and relationships between datasets and fields. Step 910 may correspond to the metadata filtering step 304A and the metadata profiling 306A described with reference to FIG. 3.

Step 910 may involve metadata profiling (e.g., the metadata profiling 306A). Metadata profiling may comprise extraction and analysis of metadata describing the structured data and analytics applications. The metadata may include information about tables, fields, associations, relationships, measures, dimensions, scripts, visualizations, and security rules. Step 910 may also involve metadata filtering (e.g., the metadata filtering step 304A). Metadata filtering may comprise selection of a subset of metadata relevant to the natural language request, producing relevant metadata (e.g., the relevant metadata 306B). The metadata filtering may use embeddings, similarity search, and heuristics to keep prompts within practical size and complexity bounds. The metadata filtering may address the challenge that a practical system cannot send all data and metadata to a large language model. Step 910 may retrieve relevant metadata context via embeddings and similarity search in a vector database (e.g., the vector database 156) before forming prompts for the large language model.

At step 920, an analysis type, relevant data fields, and filter conditions may be determined. Step 920 may use a large language model (e.g., the large language model 160 or the large language model 310) to perform the determination. Step 920 may correspond to the data analysis recommendation step 304C, the data field association step 304D, and the filter constraints identification step 304B described with reference to FIG. 3. Step 920 may involve analysis recommendation. For example, the large language model may receive the user request together with a list of supported analysis types and parameters. The large language model may recommend an analysis type suitable for the request, producing a recommended analysis (e.g., the recommended analysis 306C). The supported analysis types may comprise a curated set of analysis templates with defined parameters. For example, the supported analysis types may include fact period comparison, dimension breakdown, top-N ranking, status comparison, and trend over time analysis types. The use of supported analysis types may reduce ambiguity and improve determinism in the processing pipeline.

Step 920 may also involve field-to-parameter association, corresponding to the data field association step 304D. Given the recommended analysis and a filtered subset of application metadata (e.g., the relevant metadata 306B), the large language model may map analysis parameters to specific application fields, tables, and measures. For example, the large language model 310 may associate a measure parameter with a total sales field and a date field parameter with an order date field. The field-to-parameter association may result in a mapping of one or more fields from the application metadata to the parameters of the selected analysis type.

Step 920 may further involve filter identification, corresponding to the filter constraints identification step 304B. The large language model 310 may identify filter constraints from the natural language request. The filter constraints may include time windows, geographic regions, statuses, and threshold ranges. For example, the filter constraints may specify a last quarter time period and a same quarter prior year time period for a comparison analysis. The filter constraints may be returned in a structured format.

At step 930, an analysis definition (e.g., the analysis definition 306D or the analysis definition 452) and a filters definition (e.g., the filters definition 306E or the filters definition 450) may be generated based on the determined analysis type, relevant data fields, and filter conditions. For example, step 930 may correspond to the generation of the analysis definition 306D and the filters definition 306E. The analysis definition may comprise a structured representation of the analysis to be executed. In some cases, the analysis definition may correspond to a hypercube definition. The hypercube definition may specify dimensions, measures, sorting, aggregation functions, and other parameters, as illustrated in the analysis definition 452. The analysis definition may be derived from the selected analysis type and the parameter bindings determined at step 920. The filters definition may comprise a structured representation of constraints. The constraints may restrict or select subsets of data for the analysis. The filters definition may specify field identifiers, operators, values, and filter types, as illustrated in the filters definition 450. The filter types may include time filters, category filters, and numeric filters. The filters definition may include a logical operator specifying how multiple filter conditions are combined.

Step 930 may produce structured outputs. The structured outputs may comprise JSON objects describing the analysis type selection, parameter bindings, and filter constraints. The use of structured outputs may reduce ambiguity and support deterministic downstream execution. The system 150 may validate that proposed fields exist, match expected data types, and are permitted by security rules. If validation fails or confidence is low, the system 150 may request clarification or re-run a stage with adjusted context. At step 940, the associative engine (e.g., the associative engine 170 or the associative engine 308) may be caused to process the structured data using the analysis definition 306D and the filters definition 306E. Step 940 may correspond to the processing performed by the associative engine 308 described with reference to FIG. 3.

The associative engine 308 may receive the analysis definition 306D and the filters definition 306E as inputs. The associative engine 308 may maintain associations among data elements. The associative engine 308 may compute aggregations and relationship traversals without requiring explicit SQL joins per query. The associative engine 308 may receive inputs similar to inputs received when a user clicks and selects within an analytics application user interface, such as the analytics user interface 400. The associative engine 308 may execute the analysis definition 306D against the structured data while applying the filter constraints specified in the filters definition 306E.

At step 950, a response to the query may be generated based on the processed structured data. Step 950 may correspond to the generation of the response 306F described with reference to FIG. 3. The response (e.g., the response 306F or the response 502) may comprise a visualization (e.g., the visualization 502A or the chart 252). The visualization may be generated based on the processed structured data. The visualization may comprise a bar chart, a scatter plot, a KPI tile, or another chart type appropriate for the analysis type and user intent. The visualization type may be determined based on a visualization hint included in the analysis definition 452. The response may also comprise a natural language explanation (e.g., the natural language explanation 502B or the answer 168). The natural language explanation may describe the result of the analysis. The natural language explanation may include summary statistics, trends, deltas, percent changes, and narrative insights. The natural language explanation may be tailored to the user 153 context and conversation history. The combination of the visualization 502A and the natural language explanation 502B may provide a comprehensive understanding of the data analysis results, as illustrated in the interface 500. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving a query associated with structured data;
determining, based on the query, relevant metadata associated with the structured data comprising data elements;
determining, via a large language model and based on the query and the relevant metadata: an analysis type, relevant data fields, and filter conditions;
generating, based on the analysis type, the relevant data fields, and the filter conditions, an analysis definition and a filters definition;
causing, based on the analysis definition and the filters definition, an associative engine to process the structured data, wherein the associative engine maintains associations among the data elements;
generating, via the large language model and based on the processed structured data, a response comprising a visualization and a natural language explanation; and
sending, to a user device, the response, wherein the user device outputs the visualization and the natural language explanation.

2. The method of claim 1, wherein determining the relevant metadata comprises:
generating embeddings of the structured data; and
causing the embeddings to be stored in a vector database.

3. The method of claim 2, wherein generating the embeddings comprises:
causing the structured data to be split into chunks;
causing each chunk to be converted into an embedding using the large language model; and
causing the embeddings to be semantically indexed in the vector database.

4. The method of claim 3, further comprising determining, based on the query, relevant context by causing a similarity search to be performed on the embeddings in the vector database.

5. The method of claim 1, wherein the structured data comprises one or more analytics applications, wherein each analytics application comprises a data model, data tables, and information regarding connections to data sources.

6. The method of claim 1, wherein the analysis definition comprises a hypercube definition, wherein the hypercube definition specifies dimensions, measures, sorting, and aggregation functions.

7. The method of claim 1, wherein the query further comprises a conversation history, wherein the conversation history comprises one or more prior user requests and system responses.

8. A method comprising:
receiving a query and a conversation history associated with structured data;
determining, via a large language model and based on the query and the conversation history, relevant metadata associated with the structured data;
determining, via the large language model and based on: the query, the conversation history, and the relevant metadata, an analysis type and analysis parameters;
generating, based on the analysis type and the analysis parameters, an analysis definition;
generating, via an associative engine and based on the analysis definition, a visualization, wherein the associative engine processes the structured data; and
causing the visualization to be output to a user device, wherein the user device is associated with the query.

9. The method of claim 8, wherein determining the relevant metadata comprises:
generating embeddings of the structured data; and
causing the embeddings to be stored in a vector database.

10. The method of claim 9, wherein generating the embeddings comprises:
causing the structured data to be split into chunks;
causing each chunk to be converted into an embedding using the large language model; and
causing the embeddings to be semantically indexed in the vector database.

11. The method of claim 10, further comprising determining, based on the query, relevant context by causing a similarity search to be performed on the embeddings in the vector database.

12. The method of claim 8, wherein the structured data comprises one or more analytics applications, wherein each analytics application comprises a data model, data tables, and information regarding connections to data sources.

13. The method of claim 8, wherein the analysis type comprises one or more of a fact period comparison, a dimension breakdown, a top-N ranking, a status comparison, or a trend over time analysis.

14. The method of claim 8, further comprising generating a natural language explanation based on the processed structured data, wherein the natural language explanation describes a result of the analysis type.

15. A method comprising:
determining, based on a query and structured data, relevant metadata;
determining, based on the query and the relevant metadata, an analysis type, relevant data fields, and filter conditions;
generating, based on the analysis type, the relevant data fields, and the filter conditions, an analysis definition and a filters definition;
causing, based on the analysis definition and the filters definition, the structured data to be processed; and
generating, based on the processed structured data, a response comprising a visualization, wherein the visualization is associated with analysis type.

16. The method of claim 15, wherein the relevant metadata is determined using metadata filtering, and wherein the metadata filtering comprises:
generating embeddings of the structured data;
causing the embeddings to be stored in a vector database; and
causing a similarity search to be performed on the embeddings based on the query.

17. The method of claim 16, wherein generating the embeddings comprises:
causing the structured data to be split into chunks;
causing each chunk to be converted into an embedding; and
causing the embeddings to be semantically indexed in the vector database.

18. The method of claim 15, wherein the structured data comprises one or more analytics applications, wherein each analytics application comprises a data model, data tables, and information regarding connections to data sources.

19. The method of claim 15, wherein the analysis definition comprises a hypercube definition, wherein the hypercube definition specifies dimensions, measures, sorting, and aggregation functions.

20. The method of claim 15, wherein the response further comprises a natural language explanation, wherein the natural language explanation describes a result of the analysis type.
